(19) United States
(12) Patent Application Publication
(10) Pub. No.: US 2026/0199824 A1
(43) Pub. Date: Jul. 16, 2026

(54) KILN EXHAUST GAS REGENERATION APPARATUS AND SYSTEM, AND KILN SYSTEM

(71) Applicant: TDK CORPORATION, Tokyo (JP)

(72) Inventors: Yusho YOSHINO, Tokyo (JP); Koji MITAKE, Tokyo (JP); Toshihiro KUROSHIMA, Tokyo (JP); Katsumichi TAGAMI, Saku-city (JP); Motohiro SAKURAI, Saku-city (JP); Soichi HASHIBA, Saku-city (JP)

(73) Assignee: TDK CORPORATION, Tokyo (JP)

(21) Appl. No.: 19/137,342

(22) PCT Filed: Dec. 18, 2023
(86) PCT No.: PCT/JP2023/045245

§ 371 Date: Jun. 10, 2025

(30) Foreign Application Priority Data
Jan. 12, 2023 (JP) 2023-003071

(51) Int. Cl. B01D 53/22; B01D 53/32; B01D 53/46; B22F 9/02; B22F 9/04; C01B 23/00; F27D 17/20

(52) U.S. Cl. CPC B01D 53/229; B01D 53/326; B01D 53/46; B22F 9/023; B22F 9/04; C01B 23/0042; F27D 17/20; B01D 2256/18; B01D 2257/108; B22F 2009/049; B22F 2301/355; C01B 2210/001; C01B 2210/0034; C01B 2210/0053

(57) ABSTRACT

A kiln exhaust gas regeneration apparatus for regenerating, into reusable gas, a mixed gas emitted from a kiln that causes a metal occluding occlusion gas to be heated and causes the occlusion gas to be released from the metal in a noble-gas atmosphere. The apparatus comprises a noble gas extraction mechanism for converting the received mixed gas into a gas having an increased noble-gas-concentration, by using a filter having different degrees of permeability between occlusion gas and noble gas, and/or a fuel cell configured to oxidize occlusion gas. The noble gas may be argon gas. The apparatus may further comprise a noble gas delivery mechanism for sending the gas having an increased noble-gas-concentration to the kiln or a gas storage tank in order for the gas having an increased noble-gas-concentration to be reused as the atmosphere.

### TECHNICAL FIELD

The present disclosure relates to a technology for processing gas emitted from a kiln.

Priority is claimed on Japanese Patent Application No. JP 2023-003071 filed on Jan. 12, 2023 under the Paris Convention, and the content of the Japanese Patent Application Publication is incorporated herein by reference under PCT Rule 20.6.

### BACKGROUND ART

In recent years, rare earth magnets such as neodymium-iron-boron (Nd—Fe—B) magnets have become important materials essential for the manufacture of electric drive Systems such as electric motors for electric vehicles, and demand for such magnets is expected to increase further in the coming carbon-neutral society. Such rare earth magnet is generally manufactured by (a) coarsely pulverizing a raw alloy lump containing rare earth elements, metal elements, and boron produced by a melting method, (b) rendering (finely pulverizing) the same to alloy powder by using a jet mill or the like, and then subjecting the alloy powder to (c) compression molding in a magnetic field, (d) sintering and heat-treating the molded body, and (e) performing processing of various types. Here, the above-mentioned (a) pulverization (coarse pulverization) of the raw alloy lump is quite time-consuming, resulting in a problem of reduced overall productivity.

To address this problem, for example, PTL 1 discloses an apparatus for manufacturing a coarsely pulverized alloy powder by causing the above-mentioned raw alloy lump to occlude hydrogen and then heat-treating and pulverizing the raw alloy lump. In general, rare earth alloys containing rare earth elements have the property of occluding a large amount of hydrogen. When a raw alloy lump that has occluded a large amount of hydrogen is heated, further expansion occurs while the bonding strength between metal atoms is weakened by the presence of hydrogen atoms. As a result, cracks occur in the raw alloy lump, and self-destructive conversion into alloy powder is promoted.

The apparatus for manufacturing an alloy powder disclosed in PTL 1 is equipped with a rotatable heat treatment section that heats and dehydrogenates the alloy powder that has occluded hydrogen, and this heat treatment section has a gas supply mechanism for introducing argon gas into the heat treatment section during the heat treatment. When manufacturing the alloy powder, the heat treatment section is rotated, and the alloy power that has occluded hydrogen is heated and dehydrogenated while the argon gas is introduced into the heat treatment section. As a result, the hydrogen released from the alloy powder is quickly emitted together with the argon gas, realizing efficient dehydrogenation.

### CITATION LIST

### Patent Literature

[PTL 1] Japanese Patent Application Laid-open No. 2005-163066

### SUMMARY

### Technical Problem

Currently, in the manufacture of alloy powders for rare earth magnets, the process from the hydrogen occlusion to the conversion into alloy powder and dehydrogenation by heating, as disclosed in PTL 1, is adopted. Specifically, in a kiln, a raw alloy lump that has occluded hydrogen is coarsely pulverized and then heated to several hundred degrees Celsius in an argon gas atmosphere (non-oxidizing atmosphere) introduced into the kiln to perform coarse pulverization while releasing hydrogen gas, and then the released hydrogen gas is emitted outside the kiln together with argon gas. Incidentally, the coarsely pulverized alloy lump, i.e., the alloy powder, is transferred to the next step in a non-oxidizing atmosphere.

Here, the argon gas emitted together with hydrogen gas is in a state of gas mixed with the hydrogen gas.

Therefore, this argon gas is difficult to reuse, and conventionally it has been diluted with nitrogen gas or the like and emitted to the outside and discarded. Therefore, even though argon gas is a noble gas and very expensive, it has been necessary to introduce new argon gas for each production cycle, which has been a major obstacle to reducing production costs.

The present disclosure invention therefore aims to provide a kiln exhaust gas regeneration apparatus, system, and method for regenerating a mixed gas including a noble gas and an occlusion gas (occluded gas), emitted from the kiln as described above, into a reusable gas. It also aims to provide a kiln system for reusing the gas regenerated in this way.

### Solution to Problem

According to the present disclosure, there is provided a kiln exhaust gas regeneration apparatus comprising a noble gas extraction mechanism configured to receive a mixed gas emitted from a kiln and convert the mixed gas into a gas having an increased noble gas concentration, the mixed gas including a noble gas and an occlusion gas, the kiln causing a metal occluding the occlusion gas to be heated and causing the occlusion gas to be released from the metal in an atmosphere including the noble gas, and the noble gas extraction mechanism being configured to use, for converting the mixed gas: a filter having different degrees of permeability between the occlusion gas and the noble gas; and/or a fuel cell configured to oxidize the occlusion gas. The noble gas may be argon gas.

### BRIEF DESCRIPTION OF DRAWINGS

FIG. 1 is a schematic diagram illustrating one embodiment of a kiln exhaust gas regeneration apparatus/system and a kiln system according to the present disclosure;

FIG. 2A1, 2A2, 2B1, 2B2, 2C1, and 2C2 are graphs for explaining one example of the filtering processing according to the present disclosure;

FIGS. 3A and 3B are tables showing the results of measuring the hydrogen concentration at the hydrogen-side outlet in the example illustrated in FIG. 2A1 to 2C2;

FIG. 4A1, 4A2, 4B, 4C1, and 4C2 are graphs for explaining another example of the filtering processing according to the present disclosure;

FIGS. 5A, 5B, and 5C are schematic diagrams for explaining various embodiments of the gas filter arrangement in the filtering unit (U) according to the present disclosure;

FIG. 6 is a schematic diagram showing another embodiment of the kiln exhaust gas regeneration apparatus/system according to the present disclosure; and

FIG. 7 is a schematic diagram showing yet another embodiment of the kiln exhaust gas regeneration apparatus/system according to the present disclosure.

### DESCRIPTION OF EMBODIMENTS

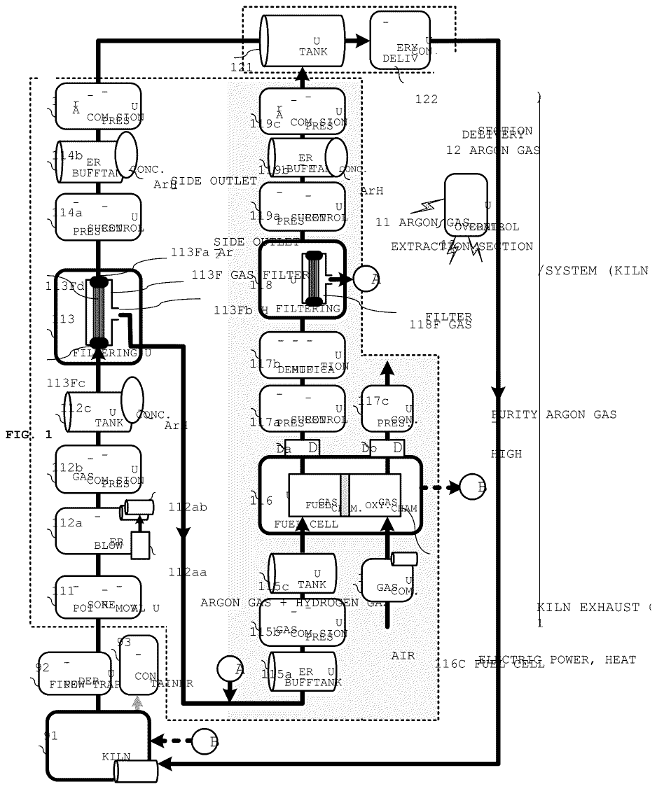

The embodiments for carrying out the present disclosure will be explained hereinbelow with reference to the appended drawings. The gas pressure values described below are absolute gas pressure values with 1 atmosphere (atmospheric pressure) being approximately 0.1 megapascals (MPa).

[Kiln Exhaust Gas Regeneration Apparatus/System, Kiln System] FIG. 1 is a schematic diagram illustrating one embodiment of a kiln exhaust gas regeneration apparatus/system and a kiln system according to the present disclosure.

A kiln exhaust gas regeneration apparatus 1 shown in FIG. 1 as one embodiment of the present disclosure is an apparatus that regenerates, into a reusable form, kiln exhaust gas emitted from a kiln 91 that produces alloy powders for rare earth magnets. Here, the rare earth magnet can be, for example, an R-T-B-based permanent magnet such as a neodymium magnet (Nd—Fe—B-based permanent magnet). This R-T-B-based permanent magnet is composed of crystal grains with an R₂T₁₄B-type crystal structure and grain boundaries therebetween. In addition, ‘R’ in the R-T-B-based permanent magnet represents at least one rare earth element. Furthermore, ‘T’ represents iron (Fe), or iron (Fe) and cobalt (Co), but may further represent the inclusion of at least one metal selected from transition metal elements other than iron (Fe) and cobalt (Co). Furthermore, ‘B’ represents boron (B), or boron (B) and carbon (C). Furthermore, the R-T-B-based permanent magnet may contain copper (Cu), aluminum (Al), and the like. The addition of such elements makes it possible to increase the coercive force, increase the corrosion resistance, or improve the temperature characteristics of the magnetic properties.

The kiln 91 is a kiln for manufacturing alloy powders of the rare earth magnets described above.

### Specifically,

(a-1) a raw alloy lump for a rare earth magnet is made to occlude an occlusion gas (hydrogen (H₂) gas in the present embodiment), and this raw alloy lump is heated at several hundred degrees Celsius in an atmosphere of an introduced noble gas (argon (Ar) gas in the present embodiment) to release the occlusion gas (occluded gas, hydrogen gas), thereby coarsely pulverizing the raw alloy lump in a self-destructive way;
(a-2) the occlusion gas (hydrogen gas) that has been released is then emitted outside the kiln 91 together with the noble gas (argon gas) as a kiln exhaust gas.

The raw alloy lump coarsely pulverized in (a-1) above is, for example, an alloy powder having a diameter of several hundred micrometers (um), and this alloy powder is recovered in an alloy powder recovery container 93 provided outside the kiln in the present embodiment. The recovered alloy powder is then finely pulverized, and further subjected to compression molding in a magnetic field, sintering, heat treatment, and the like to produce a rare earth magnet. The alloy powder removed from the kiln 91 can also be transferred directly to a device for fine pulverization without passing through the alloy powder recovery container 93.

Meanwhile, the kiln exhaust gas emitted in (a-2) above is transferred to a fine powder trap unit (U) 92, where the alloy powder remaining therein is separated and removed, and then the kiln exhaust gas is emitted from the fine powder trap U 92. As described above, this emitted kiln exhaust gas is a mixed gas containing the occlusion gas (hydrogen gas) and the noble gas (argon gas). The kiln exhaust gas regeneration apparatus 1 regenerates the kiln exhaust gas into a gas having an increased concentration of noble gas (argon gas) (hereinafter also referred to as a noble gas (argon) concentration-increased gas).

Therefore, the kiln exhaust gas regeneration apparatus 1 specifically includes:
(A) a noble gas (argon gas) extraction section (mechanism) 11 that receives the kiln exhaust gas, which is a mixed gas emitted from the kiln 91 and contains noble gas (argon gas) and occlusion gas (hydrogen gas), and converts the kiln exhaust gas into a noble gas (argon) concentration-increased gas using a gas filter 113F and/or a fuel cell 116C (both in FIG. 1).

Here, the gas filter 113F, which will be described in detail later, is a filter that has different degrees of permeability between the occlusion gas (hydrogen gas) and the noble gas (argon gas). By introducing the kiln exhaust gas into this gas filter 113F, at least a portion of the occlusion gas (hydrogen gas) is separated from the noble gas (argon gas), and thus the noble gas (argon) concentration-increased gas can be taken out.

Furthermore, the fuel cell 116C, which will also be described in detail later, is a power generation device that oxidizes the occlusion gas (hydrogen gas) (for example, by converting the occlusion gas into an oxide (water) or positive ions (H⁺) ). By introducing the kiln exhaust gas into this fuel cell 116C, at least a portion of the occlusion gas (hydrogen gas) is oxidized and removed from the kiln exhaust gas, thereby making it possible to take out the noble gas (argon) concentration-increased gas.

Furthermore, by using both such gas filter 113F and fuel cell 116C, it is possible to generate the noble gas (argon) concentration-increased gas more effectively, for example with a higher recovery rate, as will be described in detail later using FIGS. 1, 6 and 7. In any case, the kiln exhaust gas regeneration apparatus 1 can regenerate the kiln exhaust gas, which is a mixed gas emitted from the kiln 91 and contains noble gas (argon gas) and occlusion gas (hydrogen gas), into a reusable gas (noble gas (argon) concentration-increased gas).

The kiln exhaust gas regeneration apparatus 1 of the present embodiment further includes:
(B) a noble gas (argon gas) delivery section (mechanism) 12 that sends the noble gas (argon) concentration-increased gas, which has been taken out, to the kiln 91 or a gas storage unit for the kiln 91 (for example, a tank for supplying gas to the kiln 91) so that the noble gas (argon) concentration-increased gas can be reused as a noble gas (argon gas) atmosphere during the alloy powder manufacture.

The expensive noble gas (argon gas), which was previously diluted with nitrogen gas or the like and emitted and discarded to the outside after use, can thus be reused. As a result, the use of new noble gas (argon gas) and nitrogen gas for dilution can be reduced or eliminated, and the cost of manufacturing the alloy powders for rare earth magnets can be reduced. In this case, the kiln exhaust gas regeneration apparatus 1 (the noble gas extraction section (argon gas extraction section) 11, noble gas delivery section (argon gas delivery section) 12) and the kiln 91 (and possibly also the fine powder trap U 92 and the alloy powder recovery container 93) constitute one embodiment of the kiln system according to the present disclosure. In this kiln system, the regenerated noble gas (noble gas (argon) concentration-increased gas) can be reused.

In addition, when reusing the noble gas (argon) concentration-increased gas in the kiln 91, by making this noble gas (argon) concentration-increased gas a gas having a higher argon concentration (lower hydrogen concentration), the desorption of hydrogen from the raw alloy lump (dehydrogenation) can be further promoted, the processing time in the kiln 91 can be shortened, and a more efficient alloy powder manufacturing process can be performed. Furthermore, even when a prepared expensive pure argon gas is mixed with the above-mentioned argon concentration-increased gas in order to obtain the argon gas of the required high purity in such a reuse, it is possible to further reduce the amount of the pure argon gas used.

In addition, when using both the gas filter 113F and the fuel cell 116C, it is also possible to adopt a mode in which they are provided in separate apparatus. Also, the noble gas delivery section (argon gas delivery section) 12 may be a component of an apparatus separate from an apparatus including the noble gas extraction section (argon gas extraction section) 11. In any case, these apparatuses as a whole constitute one embodiment of the kiln exhaust gas regeneration system according to the present disclosure. The configuration of the kiln exhaust gas regeneration apparatus (system) 1 of the present embodiment will be described in more detail hereinbelow.

[Apparatus/System Configuration, Kiln Exhaust Gas Regeneration Method] As also shown in FIG. 1, the kiln exhaust gas regeneration apparatus (system) 1 of the present embodiment includes the argon gas extraction section (noble gas extraction section) 11, the argon gas delivery section (noble gas delivery section) 12, and an overall control unit (U) 13. Of these, the argon gas delivery section 12 has a tank U 121 and a delivery control U 122.

Further, in the present embodiment, the argon gas extraction section 11 includes:
(a) a catalytic poison removal U 111;
(b) a blower U 112a equipped with a blower 112aa and a buffer tank 112ab, a gas compression U 112b, and a tank U 112c;
(c) a filtering U 113 equipped with the gas filter 113F;
(d) a pressure control U 114a, a buffer tank U 114b, and an Ar compression U 114c;
(e) a buffer tank U 115a, a gas compression U 115b, a tank U 115c, and a gas compression U 115d;
(f) a fuel cell U 116 equipped with the fuel cell 1160;
(g) a pressure control U 117a, a dehumidification U 117b, and a pressure control U 117c;
(h) a filtering U 118 equipped with a gas filter 118F; and
(i) a pressure control U 119a, a buffer tank U 119b, and an Ar compression U 119c.

Furthermore, the kiln system of the present embodiment is configured of the kiln exhaust gas regeneration apparatus (system) 1 having these components, the kiln 91, the fine powder trap U 92, and the alloy powder recovery container 93. Incidentally, the transfer 41 material and energy and the flow of the processes performed, which are shown by connecting the components in the apparatus/system configuration diagram of FIG. 1 with arrows, can also be understood as one embodiment of the kiln exhaust gas regeneration method according to the present disclosure.

Furthermore, although such an embodiment is different from the present embodiment, the argon gas extraction section 11 may have the filtering U 113 and components (111 to 114c) provided before and after the filtering U 113, while not having (omitting) the fuel cell U 116 and components (115a to 119c, the gray area in FIG. 1) provided before and after the fuel cell U 116. Even in such an embodiment, it is possible to regenerate the kiln exhaust gas into an argon concentration-increased gas that is reusable.
<Noble Gas Extraction Means: Upstream of Filtering U 113> Also in FIG. 1, the catalytic poison removal unit U 111 removes catalytic poisons, which poison the catalyst of the fuel cell 116C to be used later, from the kiln exhaust gas (mixed gas containing argon gas (noble gas) and hydrogen gas (occlusion gas) ) emitted from the kiln 91 (fine powder trap U 92). Specifically, in the present embodiment, the catalytic poison removal unit U 111 uses an oxidation catalyst or a selective oxidation catalyst to remove carbon monoxide (CO) gas, which is a catalytic poison, from the kiln exhaust gas.

In fact, it has been confirmed that carbon monoxide (CO) gas is mostly removed from the kiln exhaust gas at a temperature of 90° C. using a metal honeycomb (model D3PT2S40C) manufactured by Tanaka Kikinzoku Kogyo Co., Ltd. In addition, the catalytic poison removal unit U 111 may further include a device for removing substances that are harmful to the gas filter 113F.

Here, it is also preferable to provide a fine powder trap mechanism or fine powder filter mechanism in upstream of the catalytic poison removal unit U 111 to remove fine rare earth magnet powder remaining in the kiln exhaust gas. This makes it possible to prevent the fine powder from adversely affecting the filtering processing and fuel cell reaction processing that are performed thereafter.

As also shown in FIG. 1, in the present embodiment, the blower U 112a uses the blower 112aa to temporarily store the kiln exhaust gas, from which the catalytic poison has been removed, in the buffer tank 112ab with a static pressure (>0.1 MPa), and then transfer the kiln exhaust gas to the gas compression U 112b. In this way, by temporarily storing the kiln exhaust gas in the buffer tank 112ab by using the blower 112aa, it is possible to suppress fluctuations in the gas pressure (of the mixed gas) inside the kiln 91.

Here, it is actually known that where the gas pressure inside the kiln 91 fluctuates significantly, the particle size and pulverization property of the alloy powder produced will change, making it difficult to stably carry out the subsequent fine pulverization, molding, sintering, and heat treatment. To solve this problem, the kiln exhaust gas is temporarily stored in the buffer tank 112ab by using the blower 112aa, so that the outlet pressure of the kiln exhaust gas emitted from the kiln 91 (fine powder trap U 92) can be stabilized to a mostly constant value, thereby suppressing fluctuations in the gas pressure inside the kiln 91.

Incidentally, the outlet pressure of the kiln 91 (fine powder trap U 92) may be set to a value, for example, within the range of 0.080 MPa to 0.110 MPa (approximately 0.790 atm to 1.086 atm). Furthermore, the variation from this set value is preferably kept within ±0.02 MPa, more preferably within ±0.01 MPa, and even more preferably within ±0.005 MPa.

Specifically, the blower 112aa is preferably an inverter-controlled blower capable of adjusting the blower capacity in response to fluctuations in the flow rate of the kiln exhaust gas emitted from the kiln 91 (fine powder trap U 92) in order to keep the outlet pressure of the kiln exhaust gas as constant as possible as described above. It is also preferable to switch between multiple blowers with different blower capacities (for example, two blowers, a large blower with a blower capacity of 3 m/in or more and a small blower with a blower capacity of 0.5 m/in or more) depending on the flow rate of the kiln exhaust gas. Of course, these blowers may also be inverter-controlled blowers.

Also in FIG. 1, the gas compression U 112b receives the kiln exhaust gas from (the buffer tank 112ab of) the blower U 112a, and transfers the received kiln exhaust gas to the mixed gas tank provided in the tank U 112c after pressurizing the kiln exhaust gas using a provided compressor (compatible with hydrogen gas and argon gas). As a result, in the present embodiment, the kiln exhaust gas is stored in this mixed gas tank at a high gas pressure of, for example, 1.1 MPa or slightly lower. Where the compressor of the gas compression U 112b is compatible with negative pressure and is an inverter-controlled compressor that can also handle fluctuations in the inlet flow rate, the blower U 112a described above can be omitted.

Furthermore, in the present embodiment, the tank U 112c transfers the kiln exhaust gas (mixed gas containing argon gas and hydrogen gas) stored in the mixed gas tank to the filtering U 113 while adjusting the flow rate with a gas regulator and a mass flow controller (or a flow switch) provided. Here, in the present embodiment, the gas pressure of the kiln exhaust gas introduced into the filtering U 113 is controlled to 0.3 MPa to 0.9 MPa by the pressure control U 114a (provided in downstream of the filtering U 113) described later. It is also preferable that the tank U 112c is equipped with a hydrogen concentration meter (or argon concentration meter) ArH that can measure the hydrogen concentration (or argon concentration) of the mixed gas stored in the mixed gas tank. The hydrogen concentration (argon concentration) measured here is used, for example, to set the filtering conditions in the filtering processing performed by the gas filter 113F described hereinbelow.

<Noble Gas Extraction Means: Filtering U 113> Also in FIG. 1, the filtering U 113 uses the provided gas filter 113F to convert the introduced kiln exhaust gas into a reusable argon concentration-increased gas, which is high-purity argon gas in the present embodiment.

In the present embodiment, the gas filter 113F is provided with:
(a) a filter inlet 113Fc for taking in the received high-pressure (0.3 MPa to 0.9 MPa in the present embodiment) kiln exhaust gas (a mixed gas containing argon gas and hydrogen gas) and introducing the taken-in gas into hollow fibers 113Fd described just below;
(b) hollow fibers 113Fd with different degrees of permeability between argon (Ar) and hydrogen (H₂) ;
(c) an argon-side outlet 113Fa which is a take-out port for the gas (high-purity argon gas in the present embodiment) that has passed through the hollow fibers 113Fd; and
(d) a hydrogen-side outlet 113Fb which is a take-out port for the gas that has permeated the hollow fibers 113Fd, i.e., the filtered gas.

Among these, the hollow fibers 113Fd in (b) above is hollow polymer fibers that preferentially transmits hydrogen molecules (H₂) over argon atoms (Ar). As high-pressure (0.3 MPa to 0.9 MPa) kiln exhaust gas flows from the filter inlet 113Fc through the hollow fibers 113Fd, hydrogen molecules selectively permeate through the polymer fibers and exit, so that a reusable argon concentration-increased gas, which is high-purity argon gas in the present embodiment, can finally be taken out from the argon-side outlet 113Fa.

Incidentally, it has been confirmed that an UBE N₂ separator that is manufactured by UBE Corporation (formerly Ube Industries Co., Ltd.) and uses aromatic polyimide hollow fibers or an N₂ membrane module nitrogen gas filter that is manufactured by Polyplastics-Evonik Corporation and also uses aromatic polyimide hollow fibers, both of which are a filter for nitrogen gas by nature, can be used as the gas filter 113F (which is a filter for argon gas).

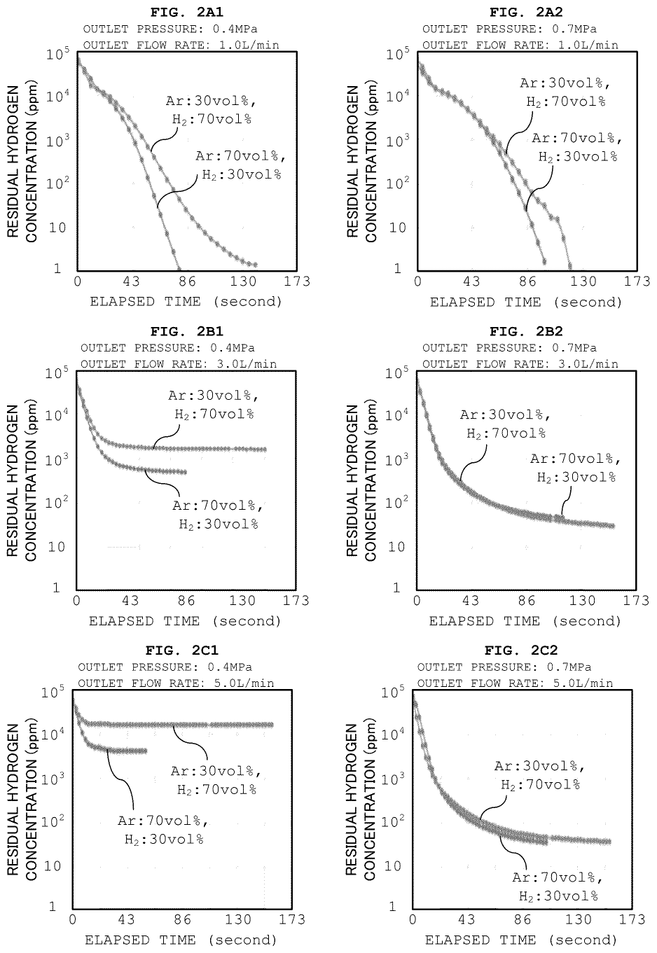

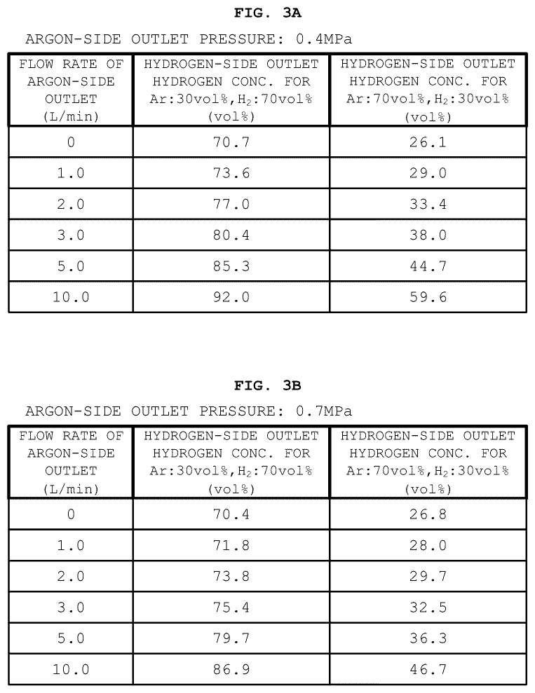

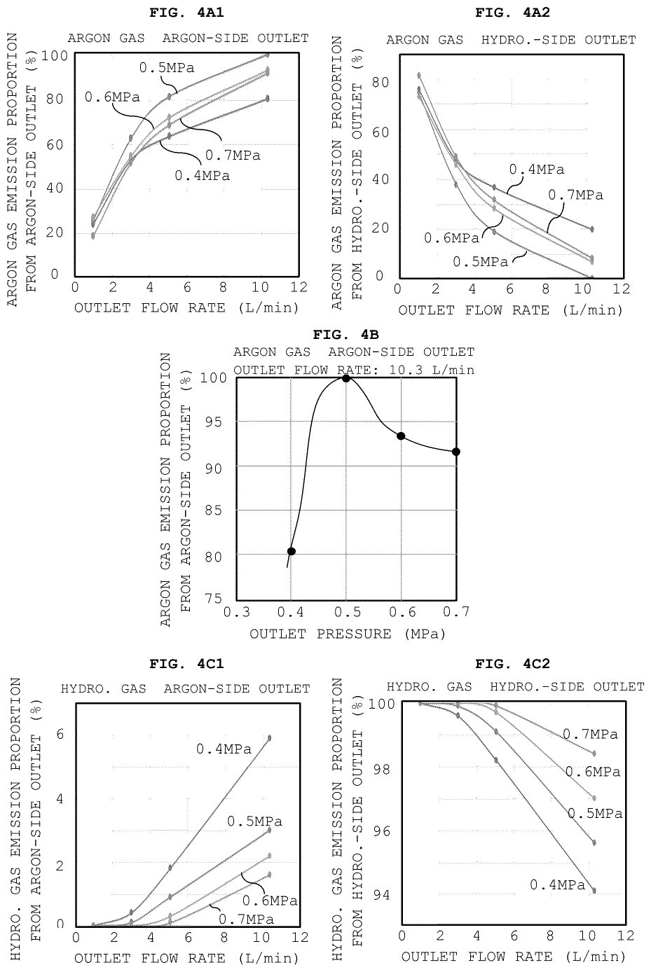

An example of filtering hydrogen from a mixed gas equivalent to the kiln exhaust gas will be described using FIG. 2A1 to 2C2, FIGS. 3A and 3B, and FIG. 4A1 to 4C2. In the example shown in these figures, the above-mentioned UBE N2 separator (2-inch diameter) is used as the gas filter 113F.

The kiln exhaust gas emitted from the kiln 91 is usually a mixed gas in which the concentration of hydrogen gas (occlusion gas) is initially higher than the concentration of argon gas, and then the concentration of argon gas becomes higher than the concentration of hydrogen gas (occlusion gas). In fact, in the kiln 91, a large amount of occluded hydrogen is initially released from the coarsely pulverized raw alloy lump. As a result, the concentration (proportion) of hydrogen gas in the kiln exhaust gas is 90 volume (vol %) or more (i.e., argon gas is 10 vol % or less).

Where the amount of hydrogen released therefrom decreases, the amount of argon gas introduced to further expel hydrogen from the raw alloy lump increases, and finally the concentration (proportion) of hydrogen gas in the kiln exhaust gas becomes 10 vol % or less (i.e., argon gas becomes 90 vol % or more).

Filtering conditions (gas pressure, gas flow rate, etc.) in the filtering processing are devised to extract suitably argon gas from the kiln exhaust gas in which the hydrogen gas concentration (hydrogen concentration) fluctuates thus over time. In the following example, these suitable filtering conditions are specifically shown.

FIG. 2A1, 2A2, 2B1, 2B2, 2C1, and 2C2 are graphs for explaining one example of the filtering processing according to the present disclosure.

FIG. 2A1 to 2C2 show the results obtained when:
(a) each of a mixed gas (argon gas (Ar):hydrogen gas (H₂)=30 vol %:70 vol %) assumed to correspond to the kiln exhaust gas emitted in the first half (of the process in the kiln 91), and a mixed gas (argon gas (Ar):hydrogen gas (H₂)=70 vol %:30 vol %) assumed to correspond to the kiln exhaust gas emitted in the second half, was introduced into the filter inlet 113Fc of the gas filter 113F;
(b) a filtering processing was performed in which each mixed gas was caused to act on the hollow fibers 113Fd under each of the conditions of the outlet pressure (gas pressure at the argon-side outlet 113Fa) having the values of 0.4 MPa and 0.7 MPa and the outlet flow rate (gas flow rate at the argon-side outlet 113Fa) having the values of 1.0 liter (L)/min, 3.0 L/min, and 5.0 L/min; and
(c) the dependence of the residual hydrogen concentration (ppm, parts per million by volume), which was the hydrogen concentration in the gas taken out from the argon-side outlet 113Fa, on the elapsed processing time was investigated.

According to FIG. 2A1, 2B1, and 2C1, when the outlet pressure is 0.4 MPa, for all mixed gases, the smaller the outlet flow rate, the smaller is the asymptotic value of the residual hydrogen concentration over the elapsed processing time (hydrogen concentration asymptotic value). Moreover, for each outlet flow rate, the mixed gas (Ar:H₂=70 vol %:30 vol %) shows a smaller hydrogen concentration asymptotic value than the mixed gas (Ar:H₂=30 vol %:70 vol %). Incidentally, when the outlet flow rate was 1.0 L/min, the hydrogen concentration asymptotic value of the mixed gas (Ar:H₂=70 vol %:30 vol %) was below the measurement limit of the concentration meter ArH and could not be measured.

Furthermore, according to FIG. 2A2, 2B2 and 2C2, even when the outlet pressure is 0.7 MPa, the hydrogen concentration asymptotic value becomes smaller as the outlet flow rate for both mixed gases decreases. In addition, this hydrogen concentration asymptotic value is smaller than when the outlet pressure is 0.4 MPa and the outlet flow rate is the same (i.e., the higher the outlet pressure, the smaller the residual hydrogen concentration).

Furthermore, when the outlet pressure is 0.7 MPa, unlike when the outlet pressure is 0.4 MPa, the hydrogen concentration asymptotic value of the mixed gas (Ar:H₂=30 vol %:70 vol %) and the hydrogen concentration asymptotic value of the mixed gas (Ar:H₂=70 vol %:30 vol %) are mostly the same at each outlet flow rate. Incidentally, when the outlet flow rate was 1.0 L/min, the hydrogen concentration asymptotic values of both mixed gases were below the measurement limit of the concentration meter ArH and could not be measured.

From the above results, it can be understood that it is also preferable to perform the filtering processing under the following filtering condition:
(a1) when the outlet pressure is set relatively low (for example, 0.4 MPa as mentioned above), at the initial stage where the hydrogen concentration of the kiln exhaust gas is high, the filtering processing is performed with as small an outlet flow rate as possible in order to achieve the target (or required) sufficiently low residual hydrogen concentration; and
(a2) thereafter, the outlet flow rate is increased stepwise (or continuously) toward a desired sufficiently large value in accordance with the decreasing hydrogen concentration value in the kiln exhaust gas (or according to the processing time elapsed) within a range in which the target (or required) sufficiently low residual hydrogen concentration can be achieved.

Furthermore, as another filtering condition, it can be understood that:
(b) when the outlet pressure is set sufficiently high (for example, 0.7 MPa as mentioned above), it is also preferable to set the outlet flow rate to a desired sufficiently large value, within a range in which the target (or required) sufficiently low residual hydrogen concentration can be achieved, regardless of fluctuations in the hydrogen concentration of the kiln exhaust gas. In any case, it is also preferable to set the outlet pressure to a larger value within the settable range.

As explained above, the filtering U 113 determines the outlet pressure and/or outlet flow rate as filtering conditions according to the (time-varying) concentration of argon gas or hydrogen gas in the received kiln exhaust gas, and performs filtering processing on the kiln exhaust gas with the determined outlet pressure and/or outlet flow rate to generate a high-purity argon gas having a target (or required) sufficiently low residual hydrogen concentration.

In other words, the filtering U 113 performs filtering processing on the kiln exhaust gas with a gas flow rate having a value set to reduce the residual hydrogen concentration, or with a gas flow rate (a desired sufficiently large gas flow rate) within the gas flow rate value range set to reduce the residual hydrogen concentration, which makes it possible to generate a high-purity argon gas having a target (or required) sufficiently low residual hydrogen concentration. It is also preferable that the outlet pressure is set to a larger value within the settable range in this filtering processing.

Incidentally, in the present example, when the outlet pressure is set to 0.4 MPa, for example, the outlet flow rate is kept at around 3.0 L/min in the first half of the process in the kiln 91 (for example, when the hydrogen concentration of the kiln exhaust gas is 70 vol %) , and the outlet flow rate is increased to around 5.0 L/min in the second half of the process (for example, when the hydrogen concentration of the kiln exhaust gas is 30 vol %), thereby making it possible to consistently produce high-purity argon gas having a residual hydrogen concentration of the 10 ppm range. Also, for example, when the outlet pressure is set to 0.7 MPa, high-purity argon gas having a residual hydrogen concentration of the 10 ppm range can be produced even if the outlet flow rate is consistently set to a large value of 5.0 L/min.

FIGS. 3A and 3B are tables showing the results of measuring the hydrogen concentration at the hydrogen-side outlet 113Fb in the example illustrated in FIG. 2A1 to 2C2. Here, as described above, a gas that has permeated the hollow fibers 113Fd, that is, the filtered gas, is emitted from the hydrogen-side outlet 113Fb of the gas filter 113F. FIG. 3A shows the hydrogen concentration of this filtered gas when the (argon-side) outlet pressure is 0.4 MPa. FIG. 3B shows the hydrogen concentration of this filtered gas when the (argon-side) outlet pressure is 0.7 MPa.

According to FIG. 3A, the hydrogen concentration of the filtered gas generated from the mixed gas (Ar:H₂=30 vol %: 70 vol %) increases from 70.7 vol % (approximately equal to 70 vol % of the original mixed gas) to 92.0 vol % as the (argon-side) outlet flow rate increases in the order of 0, 1.0, 2.0, 3.0, 5.0, and 10.0 L/min under the condition of an outlet pressure of 0.4 MPa. Furthermore, the hydrogen concentration of the filtered gas generated from the mixed gas (Ar:H₂=30 vol %:70 vol %) also shows a similar tendency regarding the increase in the (argon-side) outlet flow rate.

Furthermore, as shown in FIG. 3B, even under the condition of an outlet pressure of 0.7 MPa, the hydrogen concentration of each filtered gas shows a similar tendency regarding the increase in the (argon-side) outlet flow rate. Incidentally, the (argon-side) outlet flow rate of “0” in FIGS. 3A and 3B means that the argon-side outlet 113a of the gas filter 113F was blocked and then the mixed gas was introduced into the gas filter 113F. The hydrogen concentration of each filtered gas is smaller at the same outlet flow rate when the outlet pressure is 0.7 MPa than when it is 0.4 MPa.

According to the results shown in FIGS. 3A and 3B, the hydrogen concentration of the filtered gas is higher than that of the original mixed gas (70 vol %, 30 vol %) as a result of hydrogen selectively passing through the hollow fibers 113Fd, and the difference is larger as the outlet flow rate is higher. However, it can also be understood that due to the characteristics of the hollow fibers 113Fd (gas filter 113F), the filtered gas contains a considerable amount of argon gas. Therefore, in the present embodiment, the fuel cell U 116 is used in order to further recover the argon gas contained in this filtered gas, as will be described in detail later.

Here, using FIG. 4A1, 4A2, 4B, 4C1, and 4C2, there will be explained an example that was implemented in order to find filtering conditions that reduce the argon concentration in the filtered gas. FIG. 4A1 to 4C2 are graphs for explaining another example of the filtering processing according to the present disclosure.

Here, FIG. 4A1 and 4B are graphs showing the dependency of the argon gas emission proportion from the argon-side outlet 113Fa on (argon-side) outlet flow rate and (argon-side) outlet pressure, respectively. The argon gas (in the mixed gas) introduced from the filter inlet 113Fc to the hollow fibers 113Fd is emitted from either the argon-side outlet 113Fa or the hydrogen-side outlet 113Fb. The argon gas emission proportion from the argon-side outlet 113Fa refers to the proportion of the argon gas emitted from the argon-side outlet 113Fa.

Furthermore, the hydrogen gas emission proportion from the hydrogen-side outlet 113Fb in FIG. 4C2 is the proportion of hydrogen gas (in the mixed gas) emitted from the hydrogen-side outlet 113Fb. In addition, the emission proportion in the remaining graphs is a quantity that can be ascertained in the same way. Incidentally, in the present example, a mixed gas (Ar:H₂=50 vol %:50 vol %) is used as the mixed gas introduced into the gas filter 113F.

According to FIG. 4A1, the argon gas emission proportion from the argon-side outlet 113Fa increases as the outlet flow rate increases. Also, among the cases where the outlet pressure is 0.4, 0.5, 0.6, and 0.7 MPa, the emission proportion is the highest when the outlet pressure is 0.5 MPa. Meanwhile, not surprisingly, the argon gas emission proportion from the hydrogen-side outlet 113Fb shows the flip-side result to the above, as illustrated by FIG. 4A2.

Here, FIG. 4B shows how the argon gas emission proportion from the argon-side outlet 113Fa is the highest when the outlet pressure is 0.5 MPa. Incidentally, in this figure, the outlet flow rate is 10.3 L/min, but as can be seen from FIG. 4A1, the graph will be mostly the same for other outlet flow rate values (except for 0.1 L/min).

It can be understood from FIG. 4B that the argon gas emission proportion from the argon-side outlet 113Fa is 100% when the outlet pressure is 0.5 MPa under the condition that the outlet flow rate is 10.3 L/min. In other words, under these conditions, it is possible to recover (almost) 100% of the argon gas from the argon-side outlet 113Fa. Also, it is understood that there can be specified and set such an outlet-flow-rate range of about 10.3 L/min and such an outlet-pressure range of about 0.5 MPa that the recovery rate of argon gas from the argon-side outlet 113Fa becomes, for example, 99% or more.

Furthermore, under the above-mentioned conditions of outlet flow rate and outlet pressure, the filtered gas emitted from the hydrogen-side outlet 113Fb is (almost) 100% hydrogen gas, or a high-purity hydrogen gas mixed with, for example, 1% or less argon gas in terms of emission proportion. Therefore, in this case, the (high-purity) hydrogen gas can be also recovered from the hydrogen-side outlet 113Fb and reused, for example, as occlusion gas to be occluded in the raw alloy lump.

Furthermore, by reusing the filtered gas with a higher hydrogen concentration (lower argon concentration) in the kiln 91, it is also possible to promote the occlusion of hydrogen (hydrogen absorption) into the raw alloy lump, shorten the processing time in the kiln 91, and perform a more efficient alloy powder manufacturing process. Furthermore, in such a reuse, even when expensive pure hydrogen gas prepared in advance is mixed with the above-mentioned filtered gas to obtain hydrogen gas of the required high purity, it is possible to reduce the amount of such pure hydrogen gas used.

To summarize the above, the filtering U 113 performs a filtering processing on the kiln exhaust gas with a gas pressure having a value set to increase the argon gas recovery rate (the argon gas proportion emitted from the argon-side outlet 113Fa) or with a gas pressure within a gas pressure value range set to increase the argon gas recovery rate, thereby making it possible to recover argon gas at a sufficiently high recovery rate that is targeted (or required) (to take out a gas having an increased argon concentration). In this case, by increasing the outlet flow rate as much as possible, it is also possible to achieve a high argon gas recovery rate, for example close to 100%.

Furthermore, the filtering U 113 can also cause the kiln exhaust gas to act on the gas filter 113F, and cause a gas having an increased hydrogen concentration to be taken out from the hydrogen-side outlet 113b. In particular, in this case, by performing the filtering processing under the filtering conditions that increase the argon gas recovery rate described above, it is also possible to recover reusable high-purity hydrogen gas.

Next, the hydrogen gas emission proportion (at the argon-side outlet 113Fa and the hydrogen-side outlet 113Fb) will be explained using FIG. 4C1 and 4C2. According to FIG. 4C1, the hydrogen gas emission proportion from the argon-side outlet 113Fa becomes lower as the outlet flow rate becomes smaller and as the outlet pressure becomes higher. Meanwhile, not surprisingly, the hydrogen gas emission proportion from the hydrogen-side outlet 113Fb shows the flip-side result to the above, as illustrated by FIG. 4C2.

Therefore, where the outlet flow rate is increased, as can be seen from the results shown in FIG. 4A1 and 4A2, the recovery rate of argon gas (from the argon-side outlet 113Fa) increases, but at the same time, the amount of hydrogen gas emitted from the argon-side outlet 113Fa increases. Also, as regards the outlet pressure, the amount of hydrogen gas emitted from the argon-side outlet 113Fa is not minimized at the outlet pressure at which the recovery rate of argon gas is maximized.

From the above, it is understood that by performing filtering processing, for example, under the following filtering conditions:
(a) under an outlet pressure in a pressure range that maximizes the recovery rate of argon gas from the argon-side outlet 113Fa (for example, the range of about 0.5 MPa shown in FIG. 4B) ; and
(b) with the maximum outlet flow rate among the outlet flow rates at which the hydrogen concentration of the gas emitted from the argon-side outlet 113Fa falls below the targeted (or required) upper limit value (for example, 1.0×10 ppm), it is possible to generate as much high-purity argon gas as possible with a high recovery rate.

Furthermore, when further recovering argon gas using the fuel cell 116C, as in the present embodiment, it is also preferable to prioritize the reduction in hydrogen concentration in the filtering U 113 and perform the filtering processing with the outlet flow rate of (b) above under as high an outlet pressure as possible. Meanwhile, in another embodiment in which argon gas is recovered only by the gas filter 113F without using the fuel cell 116C, it is possible to prioritize the increase in recovery rate and perform the filtering processing with as large an outlet flow rate as possible under the outlet pressure of (a) above.

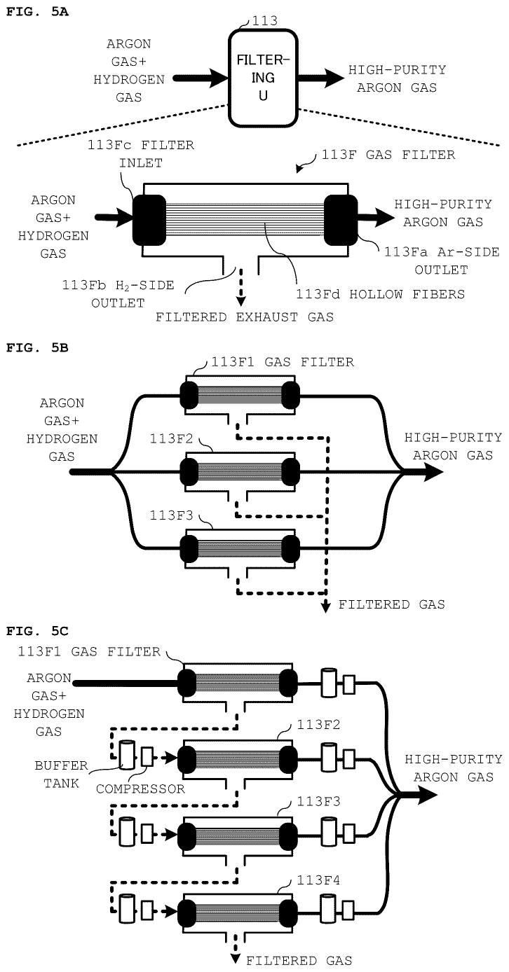

FIGS. 5A, 5B, and 5C are schematic diagrams for explaining various embodiments of the gas filter arrangement in the filtering U 113 according to the present disclosure.

FIG. 5A shows the arrangement of one gas filter 133F (as described above). The filtering U 113 may perform the filtering processing using one gas filter 133F in this way, but it is also preferable to perform the filtering processing by arranging and connecting two or three or more gas filters in parallel, as shown in FIG. 5B, in order to perform the filtering processing on the kiln exhaust gas of a larger amount (flow rate).

Specifically, in the embodiment shown in FIG. 5B, three gas filters 113F1, 113F2, and 113F3 are provided, the (high-pressure) kiln exhaust gas is divided and introduced into each gas filter (113F1, 113F2, 113F3), and the gases taken out from the argon-side outlets of the gas filters (113F1, 113F2, 113F3) are combined to form argon concentration-increased gas, which is high-purity argon gas in the present embodiment. Here, the gases emitted from the hydrogen-side outlets of the gas filters (113F1, 113F2, 113F3) are also combined and thereafter handled as the filtered gas described above.

By performing the filtering processing of the kiln exhaust gas using a plurality of gas filters arranged in parallel in this way, it is possible to reduce the outlet flow rate of each gas filter while maintaining a desired large overall outlet flow rate, and thereby suppress the hydrogen concentration of the gas emitted from the argon-side outlet to a targeted (or required) small value.

Here, an example carried out in relation to the embodiment shown in FIG. 5B will be described. In the examples shown in FIG. 2A1 to 2C2, FIGS. 3A and 3B, and FIG. 4A1 to 4C2, as described above, a gas filter (UBE N2 separator) equipped with aromatic polyimide hollow fibers having a diameter of 2 inches was used. In contrast, the filtering processing of hydrogen from a mixed gas equivalent to the kiln exhaust gas was performed using a gas filter (nitrogen gas filter manufactured by Polyplastics Evonik Corporation) equipped with aromatic polyimide hollow fibers having a diameter of 4 inches as a gas filter capable of achieving the same effect as the parallel arrangement of gas filters in FIG. 5B. Specifically, a mixed gas (Ar:H₂=70 vol %:30 vol %) was introduced into a 4-inch gas filter 113F (manufactured by Polyplastics Evonik Corporation), and the hydrogen concentration of the gas (high-purity argon gas) emitted from the argon-side outlet 113Fa was measured.

As a result, it was found that the hydrogen concentration decreases as the outlet pressure increases and the outlet flow rate decreases, similarly to the example described above (FIG. 2A1 to 2C2). However, because a large-diameter (4-inch diameter) hollow fibers 113Fd was used, high-purity argon gas having a very low hydrogen concentration of about 1 ppm could be taken out from the argon-side outlet 113Fa, for example, even under a relatively low (argon-side) outlet pressure of 0.28 MPa and a relatively large (argon-side) outlet flow rate of 10 L/min.

As yet another embodiment, as shown in FIG. 5C, the filtering processing can be also performed by connecting two, or three or more (four in FIG. 5C) gas filters in a multi-stage cascade. Specifically, in the embodiment shown in FIG. 5C, the kiln exhaust gas is introduced into a first-stage gas filter 113F1, then the gas (filtered gas) emitted from the hydrogen-side outlet of this gas filter 113F1 is introduced into a second-stage gas filter 113F2, then the gas (filtered gas) emitted from the hydrogen-side outlet of this gas filter 113F2 is introduced into a third-stage gas filter 113F3, then the gas (filtered gas) emitted from the hydrogen-side outlet of this gas filter 113F3 is introduced into a fourth-stage gas filter 113F4, and the gas emitted from the hydrogen-side outlet of this gas filter 113F4 is handled as the filtered gas mentioned above.

Furthermore, gases taken out from the gas filters (113F1, 113F2, 113F3, 113F4) are combined to become argon concentration-increased gas, which is high-purity argon gas in the present embodiment. In this way, by performing the filtering processing of the kiln exhaust gas using multiple gas filters arranged in a cascade, argon gas can be further taken out (extracted) from the gas emitted from the hydrogen-side outlet at a larger outlet flow rate or at the maximum outlet flow rate among the outlet flow rates at which the hydrogen concentration falls below the target (or required) upper limit, and as a result, it is possible to increase the recovery rate of argon gas from the kiln exhaust gas.

Here, a specific example of the recovery rate of argon gas when the embodiment shown in FIG. 5C is adopted will be described. Incidentally, the recovery rate of argon gas is calculated below as the ratio of (a) the argon-side outlet flow rate of argon gas (=(gas flow rate at the argon-side outlet)×(argon concentration at the argon-side outlet) ) to (b) the inlet flow rate of argon gas (=(gas flow rate at the inlet)×(argon concentration at the inlet)).

First, a specific example will be described in which the above-mentioned 4-inch diameter nitrogen gas filter manufactured by Polyplastics Evonik Corporation is used as each of the gas filters (113F1, 113F2, 113F3, 113F4) in the embodiment shown in FIG. 5C. With this nitrogen gas filter, it is known that, for example, when the inlet pressure is 0.32 MPa and the inlet flow rate of argon gas is within a predetermined range, the recovery rate of argon gas is approximately 0.34 (approximately 34%). Therefore, in this specific example, the inlet pressure and inlet flow rate of each gas filter (113F1, 113F2, 113F3, 113F4) are adjusted by using buffer tanks and compressors installed before and after the gas filters, so that the recovery rate of argon gas of each gas filter (113F1, 113F2, 113F3, 113F4) is set to approximately 34%.

In this case, the proportion of an argon gas recovered from the argon-side outlets of the four-stage gas filters (113F1, 113F2, 113F3, 113F4) out of the argon gas introduced into the gas filter 113F1, i.e., the recovery rate of this four-stage configuration, reaches approximately 81%.

Next, a specific example will be explained in which the above-mentioned 2-inch diameter UBE N₂ separator is used as each gas filter (113F1, 113F2, 113F3, 113F4) in this four-stage configuration. With this nitrogen gas filter, it is known that the argon gas recovery rate is approximately 60% under predetermined conditions. Therefore, also in this specific example, the inlet pressure and inlet flow rate of each gas filter (113F1, 113F2, 113F3, 113F4) are adjusted by using buffer tanks and compressors installed before and after the gas filters, so that the recovery rate of argon gas of each gas filter (113F1, 113F2, 113F3, 113F4) is set to approximately 60%.

In this case, the recovery rate of this four-stage configuration reaches approximately 97%. Furthermore, the recovery rates of a three-stage configuration and a two-stage configuration using the same nitrogen gas filter (UBE N₂ separator with a 2-inch diameter) are also high, at approximately 94% and approximately 84%, respectively. Here, the fewer the number of stages, the lower the introduction cost is and the easier it is to adjust the pressure and flow rate.

The specific example in which the recovery rate of argon gas is increased using the gas filter with a multi-stage cascade configuration has been explained above. Here, where the target (or required) recovery rate (for example, 90%) is not achieved, it is also preferable to use the fuel cell U 116 to further extract and recover argon gas from the filtered gas taken out from this multi-stage cascade configuration, as will be explained later.

<Noble Gas Extraction Means: Downstream of Filtering U 113> Returning to FIG. 1, in the present embodiment, the pressure control U 114a provided in downstream of the filtering U 113 is equipped with a back pressure valve and a pressure gauge, and controls the outlet pressure of the argon concentration-increased gas (high-purity argon gas in the present embodiment) emitted from the argon-side outlet 113Fa of the gas filter 113F, and thus the gas pressure of the kiln exhaust gas introduced into the filtering U 113.

The high-purity argon gas (argon concentration-increased gas) that has passed through the pressure control U 114a is then temporarily held in an argon gas buffer tank (with an internal tank pressure of, for example, about 0.2 MPa) provided in the buffer tank U 114b, and is then pressurized by a compressor (compatible with argon gas) provided in the Ar compression U 114c, and is thus transferred to the argon gas tank provided in the tank U 121, where it is stored.

Described above is the filtering processing of hydrogen gas in the filtering U 113. Explained hereinbelow is the process of converting the filtered gas taken out from the gas filter 113F into an argon concentration-increased gas (high-purity argon gas in the following embodiment) by using the fuel cell 116C.

<Noble Gas Extraction Means: Upstream of Fuel Cell U 116> Also in FIG. 1, the filtered gas (mixed gas containing argon gas and hydrogen gas) emitted from the hydrogen-side outlet 113Fb of the gas filter 113F is temporarily held in a mixed gas buffer tank (tank internal pressure: for example, about 0.2 MPa) provided in the buffer tank U 115a, and is then pressurized by a compressor (compatible with argon gas and hydrogen gas) provided in the gas compression U 115b, and is thus transferred to a gas tank for mixed gas provided in the tank U 115c, where it is stored.

Then, this stored mixed gas is transferred to a fuel gas chamber-side inlet of the fuel cell U 116 at a high gas pressure of 0.2 MPa to 1.0 MPa in the present embodiment. Here, this gas pressure is controlled by the pressure control U 117a (in downstream of the fuel cell U 116) described later. Also, the gas flow rate when the gas is transferred to the fuel gas chamber-side inlet is controlled by a gas regulator and a mass flow controller (or flow switch) provided in the tank U 115c.

Also in FIG. 1, in the present embodiment, the gas compression U 115d takes in air, for example, from the atmosphere, and transfers the air to an oxidizing gas chamber-side inlet of the fuel cell U 116 at a high gas pressure of 0.2 MPa to 1.0 MPa in the present embodiment by means of a provided compressor. Also, of course, the compressed air may first be stored in a provided air tank before being transferred to the fuel cell U 116.

<Noble Gas Extraction Means: Fuel Cell U 116> Also in FIG. 1, in the fuel cell U 116, the fuel cell 116C is used to oxidize (for example, to water (H₂O) or to positive ions (H⁺) ) hydrogen (H₂) in the mixed gas (containing argon gas and hydrogen gas) introduced into the fuel gas chamber, thereby converting the introduced mixed gas into an argon concentration-increased gas (or high-purity argon gas).

More specifically, in the fuel cell U 116 of the present embodiment,
(a) the mixed gas (filtered gas) that was transferred from the tank U 115c and contains argon gas and hydrogen gas is taken into the fuel gas chamber of the fuel cell 116C at a high gas pressure of 0.2 MPa to 1.0 MPa, while
(b) the air transferred from the gas compression U 115d is taken into the oxidizing gas chamber of the fuel cell 116C at a high gas pressure of 0.2 MPa to 1.0 MPa, which is the same as the pressure of the mixed gas (a) above, and
(c) a fuel cell reaction is induced between the hydrogen contained in the mixed gas of (a) above and the oxygen contained in the air of (b) above through an electrolyte layer provided between the fuel gas chamber and the oxidizing gas chamber.

Then, as a result of the fuel cell reaction, the fuel cell U 116 outputs:
(d) exhaust gas having reduced hydrogen concentration (i.e., argon concentration-increased gas) emitted from the outlet on the fuel gas chamber side (hydrogen electrode) of the fuel cell 116C;
(e) exhaust gas having reduced oxygen concentration emitted from the outlet on the oxidizing gas chamber side (oxygen electrode) of the fuel cell 1160;
(f) electric power (electromotive force) generated between the hydrogen electrode of the fuel gas chamber and the oxygen electrode of the oxidizing gas chamber; and
(g) heat (a quantity of heat) as a chemical reaction heat generated by the fuel cell reaction.

Of these, the electric power of (f) above is provided to the kiln 91 and can be used as electric power for, for example, a heating process in the kiln 91. Furthermore, the heat of (g) above can also be provided to the kiln 91 using a heat exchange means and be used as a base heat for, for example, the heating process in the kiln 91.

Here, in the present embodiment, both the hydrogen contained in the mixed gas of (a) above and the oxygen contained in the air of (b) above participate in the fuel cell reaction proceeding through the electrolyte layer at a high pressure of 0.2 MPa to 1.0 MPa, i.e., at a higher physical density, as described above. As a result, the efficiency of the fuel cell reaction is improved, and the exhaust gas of (a) above becomes an argon concentration-increased gas having a further reduced hydrogen concentration (and therefore a further increased argon concentration).

Of course, the fuel cell U 116 may be one that proceeds with the fuel cell reaction under normal conditions that are not high-pressure conditions as described above. However, by introducing the mixed gas of (a) above and the air of (b) above into the fuel cell 116C at a pressure exceeding atmospheric pressure (about 0.1 MPa), more preferably at a pressure of 0.2 MPa or higher, it is also possible to take out an argon concentration-increased gas having a further reduced hydrogen concentration (or high-purity argon gas).

Furthermore, the fuel cell 116C may have a known configuration, for example, a configuration in which plural cells having a structure in which an electrolyte layer is sandwiched between an air electrode (oxygen electrode, negative electrode, cathode) and a hydrogen electrode (fuel electrode, positive electrode, anode) are stacked (laminated) with separators interposed therebetween. In this case, each cell has a structure in which an oxidizing gas chamber on the air electrode side and a fuel gas chamber on the hydrogen electrode side are provided so as to sandwich the electrolyte layer.

Furthermore, in the present embodiment, the fuel cell 116C may be a polymer electrolyte fuel cell (PEFC).

PEFCs operate at relatively low temperatures and can be made compact in cell size, and are therefore used in, for example, many fuel cell vehicles. However, it is of course possible to use a solid oxide fuel cell (SOFC), a phosphoric acid fuel cell (PAFC), a molten carbonate fuel cell (MCFC), or the like as the fuel cell 116C. Of these, SOFCs have high power generation efficiency and usually operate at about 700° C. to 1000° C., making it possible to supply exhaust gas, i.e., the argon concentration-increased gas, at a fairly high temperature.

Incidentally, it has been confirmed that in the fuel cell 116C, even if argon, which does not contribute to the fuel cell reaction (is not oxidized), is mixed in the fuel gas chamber, power is generated according to the amount of hydrogen in the fuel gas chamber and the amount of oxygen in the oxidized gas. In other words, it is known that argon in the mixed gas does not generally have a negative effect on the fuel cell reaction, even if the concentration thereof is around 70 vol %. This fact makes it possible for the fuel cell 116C to oxidize, by performing its inherent function, the hydrogen in the mixed gas and generate the argon concentration-increased gas (or high-purity argon gas).

<Noble Gas Extraction Means: Downstream of Fuel Cell U 116> As also shown in FIG. 1, the exhaust gas having reduced hydrogen concentration, i. e., argon concentration-increased gas (or high-purity argon gas), emitted from the fuel gas chamber-side outlet of the fuel cell 116C, has some condensation water removed in a drain Da, and the gas pressure of the exhaust gas (as the back pressure of the fuel cell 116C) is controlled by the pressure control U 117a equipped with a back pressure valve and a pressure gauge. After that, the exhaust gas is dehumidified in the dehumidification U 117b, and in the present embodiment, it is transferred to the filtering U 118 described later.

Here, in the present embodiment, the dehumidification U 117b is a unit that reduces or removes moisture and water vapor in the mixed gas using a dry filter having a water vapor permeable hollow-fiber membrane. In this case, the gas pressure (0.3 MPa to 0.9 MPa in the present embodiment) of the argon concentration-increased gas introduced into the dry filter is controlled by the pressure control U 119a (in downstream of the filtering U 118), which will be described later. In a modified embodiment, the dehumidification U 117b may be a unit that reduces or removes moisture and water vapor in the mixed gas using a dehumidifier containing silica gel or zeolite, a dehumidification device equipped with a pressurizing mechanism, a gas-liquid separator, or the like.

Meanwhile, the exhaust gas (as low-oxygen air) emitted from the oxidizing gas chamber has condensation water removed to a certain extent in a drain Db, and is discarded (released) into the atmosphere in the present embodiment after the gas pressure thereof (as the back pressure of the fuel cell 116C) has been controlled by the pressure control U 117c equipped with a back pressure valve and a pressure gauge.

As another embodiment, the gas (emitted from the fuel gas chamber-side outlet) dehumidified by the dehumidification U 117b may be transferred to the buffer tank 119b and further to the tank U 121 through the pressure control U 119a described later, as argon concentration-increased gas (or high-purity argon gas), without passing through the filtering U 118 described later. For example, when an argon concentration-increased gas having a targeted (or required) high argon concentration is obtained by processing in the fuel cell U 116, it is also preferable to adopt such an embodiment.

<Noble Gas Extraction Means: Filtering U 118> Also in FIG. 1, in the filtering U 118, the provided gas filter 118F is used to convert the argon concentration-increased gas, which is emitted from the fuel gas chamber of the fuel cell 116C and introduced through the pressure control U 117a and the dehumidification U 117b, into an argon concentration-increased gas having a further increased argon concentration, which in the present embodiment is high-purity argon gas.

Here, in the present embodiment, the gas filter 118F can be the same as the gas filter 113F described above.

In the filtering U 118, such a gas filter 118F is preferably used to perform filtering processing under the filtering conditions that have been set based on the residual hydrogen concentration of the introduced argon concentration-increased gas, which are the same filtering conditions (outlet pressure, outlet flow rate, etc.) as those described for the gas filter 113F (using FIG. 2A1 to 2C2, FIGS. 3A and 3B, and FIG. 4A1 to 4C2). In the present embodiment, the gas flow rate to the gas filter 118F is controlled by a gas regulator and a mass flow controller (or a flow switch) provided in the dehumidification U 117b.

Furthermore, the filtering U 118 may also use a plurality of gas filters 118F arranged and connected in the Same manner as in the configuration shown in FIGS. 5B and 5C to generate high-purity argon gas (argon concentration-increased gas). It is also preferable that the filtered gas emitted from the hydrogen-side outlet of the gas filter 118F is returned to (just before) the buffer tank U 115a and processed again in the fuel cell U 116. This makes it possible to further reduce the hydrogen gas content in the filtered gas and also to reduce the amount of argon gas that is discarded (released), thereby increasing the final recovery rate of argon gas.

In any case, in the present embodiment, the filtering U 118, like the filtering U 113 described above, can output high-purity argon gas having a residual hydrogen concentration of, for example, 10 ppm to 103 ppm range from the argon-side outlet of the gas filter 118F.

<Noble Gas Extraction Means: Downstream of Filtering U 118> Also in FIG. 1, in the present embodiment, the pressure control U 119a provided in downstream of the filtering U 118 is equipped with a back pressure valve and a pressure gauge and controls the outlet pressure of the high-purity argon gas (argon concentration-increased gas) emitted from the argon-side outlet of the gas filter 118F, and thus controls the gas pressure of the argon concentration-increased gas introduced into filtering U 118. In the present embodiment, the pressure control U 119a also controls the gas pressure of the argon concentration-increased gas introduced into the dehumidification U 117b (in the present embodiment, including a dry filter) provided in upstream of the filtering U 118.

In the present embodiment, the high-purity argon gas (argon concentration-increased gas) that has passed through the pressure control U 119a is then temporarily stored in the argon gas buffer tank provided in the buffer tank U 119b, and if necessary, is pressurized by a compressor (compatible with argon gas) provided in the Ar compression U 119c, and then transferred to an argon gas tank provided in the tank U 121, where it is stored.

As described above in detail, in the argon gas extraction section 11 of the present embodiment, by using the fuel cell U 116 (and in the present embodiment, the filtering U 118 as well) provided in downstream of (the hydrogen-side outlet 113Fb of the gas filter 113F provided in) the filtering U 113, it is possible to further increase the recovery rate of argon gas from the kiln exhaust gas.

In the argon gas extraction section 11 of the present embodiment, the gas pressure of the kiln exhaust gas (mixed gas) to be treated is 0.3 MPa to 0.9 MPa in the filtering U 113, 0.2 MPa to 1.0 MPa in the fuel cell U 116 provided in downstream thereof, and 0.3 MPa to 0.9 MPa in the filtering U 118 provided in downstream thereof. In addition, in the units and flow paths between them (and also in the fuel cell U 116, the dehumidification U 117b (equipped with a dry filter), and the filtering U 118), a gas pressure exceeding atmospheric pressure (approximately 0.1 MPa), which is a high gas pressure of 0.2 MPa or more in the present embodiment, is maintained. In other words, the argon gas extraction section 11 in the present embodiment is a system including a series of high-pressure gas processing.

This promotes the filtering process and fuel cell reaction, which are essential for the extraction and recovery of argon gas, and makes it possible to generate a larger amount (for example, a larger gas flow rate) of argon concentration-increased gas (high-purity argon gas) with a higher argon concentration. It is also possible to further increase the final recovery rate of argon gas (from the kiln exhaust gas). However, as already mentioned, it is of course possible to operate the fuel cell 116C in a normal state (not at high pressure as in the present embodiment). In this case, a gas compression U is provided immediately before the filtering U 118.

<Noble Gas Delivery Means: Tank U, Delivery Control U> Also in FIG. 1, the tank U 121 stores, at a predetermined gas pressure, (a) high-purity argon gas (argon concentration-increased gas) transferred from the Ar compression U 114c and (b) high-purity argon gas (argon concentration-increased gas) transferred from the Ar compression U 119c. Here, in the present embodiment, this predetermined gas pressure is set according to the set (or required) supply gas pressure when supplying high-purity argon gas (argon concentration-increased gas) to the kiln 91.

Also in FIG. 1, the delivery control U 122 is a unit that is equipped with a gas regulator and a mass flow controller (or flow switch) and supplies, at a set (or required) predetermined gas flow rate, high-purity argon gas (argon concentration-increased gas) taken out from the tank U 121 to the kiln 91.

<Overall Control Means> Also in FIG. 1, in the present embodiment, the overall control U 13 is equipped with a memory that stores an overall control program and a processor (computer), further includes a communication interface that can communicate with a predetermined unit provided in the argon gas extraction section 11 and the argon gas delivery section 12, and can:
(a) send control signals to the filtering U 113 and the predetermined units located therebefore and thereafter and set and adjust the filtering conditions (outlet pressure, outlet flow rate, etc.) during the filtering process based on the contents (hydrogen concentration or argon concentration) of the monitor signals received from the hydrogen concentration meters (or argon concentration meters) ArH provided in the tank U 112c and the buffer tank U 114b;
(b) control the start and end of the fuel cell reaction in the fuel cell U 116, send control signals to the fuel cell U 116 and to predetermined units located therebefore and thereafter, and set and adjust various conditions of the fuel cell reaction (such as the flow rate and pressure of the gas introduced into the fuel cell 116C);
(c) send control signals to the filtering U 118 and the predetermined units located therebefore and thereafter and set and adjust the filtering conditions (outlet pressure, outlet flow rate, etc.) during the filtering process based on the contents (hydrogen concentration or argon concentration) of the monitor signals received from the hydrogen concentration meters (or argon concentration meters) ArH provided in the dehumidification U 117b and the buffer tank U 119b; and
(d) receive an instruction to supply high-purity argon gas (argon concentration-increased gas) from the outside, send a control signal to the delivery control U 122, and cause the delivery control U 122 to send (provide) high-purity argon gas (argon concentration-increased gas) at the designated gas flow rate to the kiln 91.

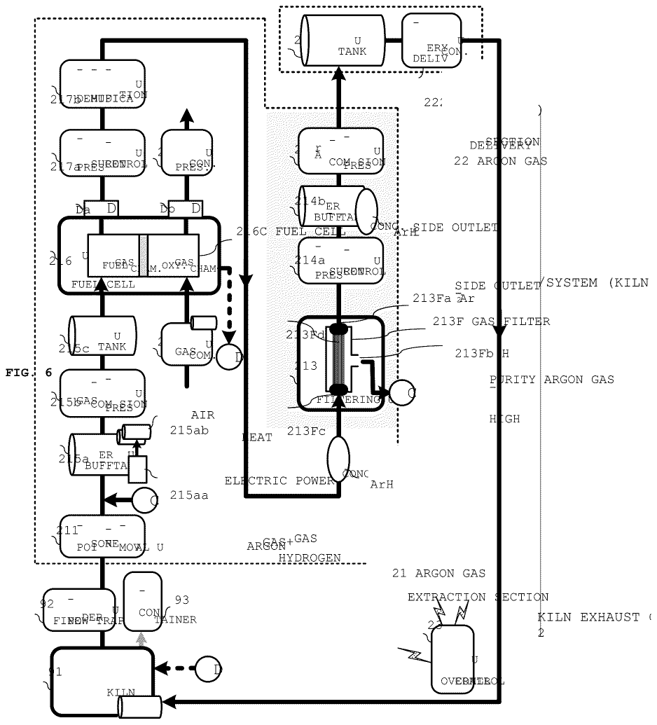

The above control processes (a) to (d) are realized by the processor (computer) that is installed in the overall control U 13 and executes the abovementioned overall control program.

[Another Embodiment of Kiln Exhaust Gas Regeneration Apparatus/System] FIG. 6 is a schematic diagram showing another embodiment of the kiln exhaust gas regeneration apparatus/system according to the present disclosure.

As shown in FIG. 6, in the kiln exhaust gas regeneration apparatus (system) 2 of the present embodiment, the kiln exhaust gas emitted from the kiln 91 (fine powder trap U 92) is first processed in a fuel cell U 216 and converted into argon concentration-increased gas (high-purity argon gas). Next, this argon concentration-increased gas (high-purity argon gas) is processed in the filtering U 213 provided in downstream of the outlet on the fuel gas chamber side (hydrogen electrode side) of the fuel cell 216C (provided in the fuel cell U 216) to generate high-purity argon gas (argon concentration-increased gas).

Specifically, the kiln exhaust gas regeneration apparatus (system) 2 includes an argon gas extraction section (noble gas extraction section) 21, an argon gas delivery section (noble gas delivery section) 22, and an overall control U 23. Of these, the argon gas delivery section 22 has a tank U 221 and a delivery control U 222. Furthermore, in the present embodiment, the argon gas extraction section 21 includes:
(a) a catalytic poison removal unit U 211;
(b) a buffer tank U 215a, a gas compression U 215b, a tank U 215c, and a gas compression U 215d;
(c) a fuel cell U 216 equipped with a fuel cell 216C;
(d) a pressure control U 217a, a dehumidification U 217b, and a pressure control U 217c;
(e) a filtering U 213 equipped with a gas filter 213F; and
(f) a pressure control U 214a, a buffer tank U 214b, and an Ar compression U 214c.

Here, the above-mentioned component ‘(name) 2**(*)’ (where * is a number or an English letter) can be considered as a component having the same structure and function as the component ‘(name) 1**(*)’, which has the same ‘(name)’ and ‘**(*)’ as those of the ‘(name) 2**(*)’, of the kiln exhaust gas regeneration apparatus (system) 1 shown in FIG. 1. For example, the fuel cell 216C and the fuel cell U 216 may have the same structure and function as the fuel cell 116C (FIG. 1) and the fuel cell U 116 (FIG. 1), respectively. However, in the present embodiment, the buffer tank U 215a is a unit that includes not only a buffer tank (215ab) but also a blower 215aa. Here, the blower 215aa and buffer tank 215ab have the same structure and function as the blower 112aa and the buffer tank 112ab of the blower U 112a (FIG. 1), respectively.

With this kiln exhaust gas regeneration apparatus (system) 2, the kiln exhaust gas can also be regenerated into a reusable argon concentration-increased gas, in the present embodiment, high-purity argon gas.

In the present embodiment, the filtered gas emitted from the hydrogen-side outlet 213Fb of the gas filter 213F provided in the filtering U 213 may be preferably returned to (just before) the buffer tank U 215a and processed again in the fuel cell U 216. This makes it possible to reduce the amount of argon gas to be discarded (released) and increase the final recovery rate of argon gas.

Furthermore, in the argon gas extraction section 21 of the present embodiment as well, the gas pressure of the kiln exhaust gas (mixed gas) to be processed is 0.2 MPa to 1.0 MPa in the fuel cell U 216, and 0.3 MPa to 0.9 MPa in the filtering U 213 provided in downstream thereof. In addition, in the units and flow paths between them (and also in the fuel cell U 216, the dehumidification U 217b (equipped with a dry filter), and the filtering U 213), a gas pressure exceeding atmospheric pressure (approximately 0.1 MPa), which is a high gas pressure of 0.2 MPa or more in the present embodiment, is maintained. In other words, the argon gas extraction section 21 in the present embodiment is also a system including a series of high-pressure gas processing.

This promotes the filtering process and fuel cell reaction, which are essential for the extraction and recovery of argon gas, and makes it possible to generate a larger amount (for example, a larger gas flow rate) of argon concentration-increased gas (high-purity argon gas) with a higher argon concentration. It is also possible to further increase the final recovery rate of argon gas (from the kiln exhaust gas). However, as already mentioned, it is of course possible to operate the fuel cell 216C in a normal state (not at high pressure as in the present embodiment). In this case, a gas compression U is provided immediately before the filtering U 213.

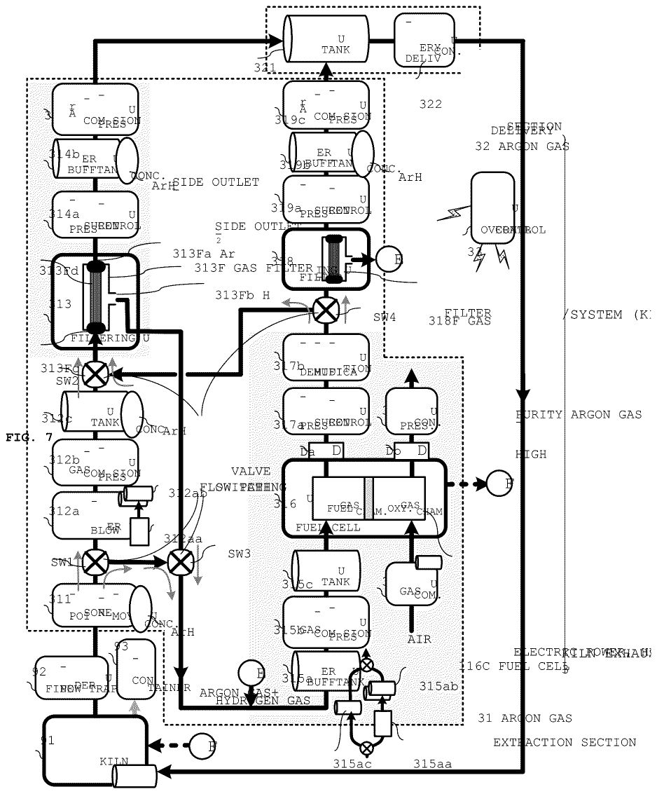

FIG. 7 is a schematic diagram showing yet another embodiment of the kiln exhaust gas regeneration apparatus/system according to the present disclosure.

As shown in FIG. 7, in a kiln exhaust gas regeneration apparatus (system) 3 of the present embodiment, which one or both of a filtering U 313 and a fuel cell U 316 (and further a filtering U 318) to use is determined based on the argon concentration or hydrogen concentration in the kiln exhaust gas emitted from the kiln 91 (fine powder trap U 92), based on a preset time schedule, or based on an external instruction, and the received kiln exhaust gas is regenerated into a reusable argon concentration-increased gas, which is high-purity argon gas in the present embodiment, using the determined filtering U 313 and/or fuel cell U 316 (and further the filtering U 318).

In the present embodiment, the kiln exhaust gas regeneration apparatus (system) 3 includes plural components ‘(name) 3**(*)’ (where * is a number or an English letter) each of which corresponds to a component ‘(name) 1**(*)’ of the kiln exhaust gas regeneration apparatus (system) 1 (FIG. 1), and the component ‘(name) 3**(*)’ can be considered as a component having the same structure and function as the component ‘(name) 1**(*)’ that has the same ‘(name)’ and ‘**(*)’ as those of the ‘(name) 3**(*)’.

However, in the present embodiment, a buffer tank U 315a is a unit that includes not only a buffer tank (315ac), but also a blower 315aa and a buffer tank 315ab. Here, the blower 315aa and the buffer tank 315ab have the same structure and function as the blower 112aa and the buffer tank 112ab of the blower U 112a (FIG. 1), respectively, and the buffer tank 315ac has the same structure and function as the buffer tank of the buffer tank U 115 (FIG. 1). Furthermore, in the present embodiment, the buffer tank U 315a also has flow path switching valves that switch the flow path so that the buffer tank 315ac can be used in the case of <flow path 1> described later, while the blower 315aa and the buffer tank 315ab can be used in the case of <flow path 2> described later.

The kiln exhaust gas regeneration apparatus (system) 3 of the present embodiment further includes:
(a) a flow path switching valve SW1 that is provided between the catalytic poison removal U 311 and the blower U 312a and is capable of transferring a gas transferred from the catalytic poison removal U 311 to a determined one of the blower U 312a and a flow path switching valve SW3 described hereinbelow;
(b) a flow path switching valve SW2 that is provided between the tank U 312c and the filtering U 313 and is capable of transferring, to the filtering U 313, a gas transferred from a determined one of the tank U 312c and a flow path switching valve SW4 described hereinbelow;
(c) a flow path switching valve SW3 that is provided between a hydrogen-side outlet 313Fb of the gas filter 313F (provided in the filtering U 313) and the buffer tank U 315a and is capable of transferring, to the buffer tank U 315a, a gas transferred from a determined one of the gas filter 313F and the above-mentioned flow path switching valve SW1; and
(d) a flow path switching valve SW4 that is provided between the dehumidification U 317b and the filtering U 318 and is capable of transferring a gas transferred from the dehumidification U 317b to a determined one of the filtering U 318 and the above-mentioned flow path switching valve SW2.

In the present embodiment, the overall control U 33 determines control signals for controlling the switching by the flow path switching valves SW1 to SW4 based on:
(a) the contents (hydrogen concentration or argon concentration) of the monitor signal received from the hydrogen concentration meter (or argon concentration meter) ArH provided in the catalytic poison removal U 311;
(b) a preset switching time schedule; or
(c) the contents (the contents specifying one of the flow paths 1 to 3 shown hereinbelow) of an instruction received from outside, and sends the control signals to the flow path switching valves SW1 to SW4 to realize, as appropriate, one of the flow paths (flow path patterns) 1 to 3 shown hereinbelow.

<Flow path 1> Kiln 91 (fine powder trap 92) catalytic poison removal U 311 to tank U 312c→filtering U 313→pressure control U 314a to Ar compression U 314c→tank U 321→delivery control U 322; and filtering U 313→(buffer tank 315ac of) buffer tank U 315a to tank U 315c→fuel cell U 316→pressure control U 317a→dehumidification U 317b→filtering U 318→pressure control U 319a to Ar compression U 319c→tank U 321→delivery control U 322;
<Flow path 2> Kiln 91 (fine powder trap 92)→catalytic poison removal U 311→(blower 315aa and buffer tank 315ab of) buffer tank U 315a to tank U 315c→fuel cell U 316→pressure control U 317a→dehumidification U 317b→filtering U 313 pressure control U 314a to Ar compression U 314c→tank U 321→delivery control U 322 (in this case, the flow path switching valve SW3 releases (discards) only gas from the hydrogen-side outlet 313Fb); and
<Flow path 3> Kiln 91 (fine powder trap 92)→catalytic poison removal U 311 to tank U 312c→filtering U 313→pressure control U 314a to Ar compression U 314c→tank U321→delivery control U 322 (fuel cell U 316 is not used).

In a modified embodiment, it is also possible not to provide (possible to omit) the filtering U 318 in the above <flow path 1>. In this case, the argon concentration-increased gas (high-purity argon gas) transferred from the dehumidification U 317b located in downstream of the fuel cell U 316 passes through the flow path switching valve SW4 and is transferred through the pressure control U 319a to, for example, the buffer tank U 319b.

Here, it is also preferable that the overall control U 33 performs, for example, the following control:
(A) when the hydrogen concentration of the received kiln exhaust gas is greater than a predetermined threshold (e.g., 50 vol %), first, <flow path 2> is realized in which a fuel cell reaction process is initially implemented in order to sufficiently reduce the hydrogen concentration, and thus high-purity argon gas (argon concentration-increased gas) is generated; and
(B) when the hydrogen concentration of the received kiln exhaust gas is equal to or less than a predetermined threshold (e.g., 50 vol %), <flow path 1> is realized in which a filtering process is initially implemented in order to generate argon gas having a smaller absolute value of hydrogen concentration, i.e., with a higher (absolute) purity of argon, and thus high-purity argon gas (argon concentration-increased gas) is generated.

Incidentally, the kiln exhaust gas in (A) above corresponds to the gas emitted in the first half of the alloy powder manufacturing process in the kiln 91 (e.g., a period of several tens of minutes from the start of the process). In the first half, a large amount of the occluded hydrogen is released by the heat treatment in the kiln 91, and the flow rate of the argon gas introduced into the kiln 91 is still small (compared to the second half, which will be described hereinbelow), so the kiln exhaust gas in the first half has a high hydrogen concentration (for example, 60 vol % to 90 vol %).

Meanwhile, the kiln exhaust gas in (B) above corresponds to the gas emitted in the second half of the alloy powder manufacturing process in the kiln 91 (for example, a period from the point when several tens of minutes have passed since the start of the process to the end of the process). In the second half, the flow rate of the introduced argon gas increases significantly (for example, several to several tens of times higher than in the first half), and the release of the occluded hydrogen approaches completion, so the kiln exhaust gas has a low hydrogen concentration (for example, 30 vol % or less).

Therefore, it is also preferable that the overall control U 33 performs control by selecting <flow path 2> in (A) above upon initially receiving the kiln exhaust gas from the kiln 91 (fine powder trap U92), and then selecting <flow path 1> in (B) above when the hydrogen concentration of the kiln exhaust gas falls below a predetermined threshold (e.g., 50 vol %), or when a predetermined time (e.g., several tens of minutes) elapses since the selection of <flow path 2>. By performing such control, it becomes possible to consistently and stably generate high-purity argon gas (argon concentration-increased gas) with the desired (or required) high argon concentration, despite significant changes in the hydrogen concentration (argon concentration) of the kiln exhaust gas emitted from the kiln 91.

In addition, in accordance with the above-mentioned control, it is also preferable that both the buffer tank 312ab and the buffer tank 315ab are provided with a first-half tank for storing the kiln exhaust gas emitted in the first half of the alloy powder manufacturing process and a second-half tank for storing the kiln exhaust gas emitted in the second half, and that the kiln exhaust gas is stored in the first-half tank (second-half tank) when the kiln exhaust gas emitted in the first half (second half) is received. Here, it is also preferable that the second-half tank has a larger capacity than the first-half tank, for example, several times to several tens of times, in order to accommodate the higher flow rate of the kiln exhaust gas in the second half.

By using such buffer tanks 312ab and 315ab, it is possible to more efficiently generate high-purity argon gas (argon concentration-increased gas) by appropriately accommodating the increase in the kiln exhaust gas flow rate in the second half of the alloy powder manufacturing process in the kiln 91. It is also possible to stabilize the gas pressure in the kiln 91 and thus contribute to the implementation of an efficient or low-cost alloy powder manufacturing process. Naturally, the buffer tank 112ab (FIG. 1) and the buffer tank 215ab (FIG. 6) may also be equipped with a first-half tank and a second-half tank as described above, and be set to switch between the first-half tanks and the second half tanks to be used as described above.

In addition, as another embodiment related to the selection of a flow path (flow path pattern) , the overall control U 33 may determine (the dependence on the kiln-exhaust-gas hydrogen concentration of) the argon concentration, gas flow rate, and recovery rate of the argon concentration-increased gas generated in the case of each flow path (flow path pattern) by a preceding experiment in which the hydrogen concentration of the kiln exhaust gas was changed, and may use the determined contents to select and realize a flow path (flow path pattern) based on the hydrogen concentration of the received kiln exhaust gas (and the required specifications of the argon concentration-increased gas).

Furthermore, when the target (required) argon concentration (purity), gas flow rate, recovery rate, and the like can be achieved by using only the filtering U 313, the overall control U 33 may be set to realize <flow path 3> upon receiving an external instruction designating <flow path 3> and generate high-purity argon gas (argon concentration-increased gas). In addition, in such a case, the setting may be to select <flow path 3> instead of <flow path 1> in the (B) of the above-described embodiment. Furthermore, upon receiving an external instruction designating a predetermined flow path due to reasons such as maintenance, testing, or unit failure, the overall control U 33 may be set to realize the predetermined flow path (flow path pattern) and generate high-purity argon gas (argon concentration-increased gas).

When selecting a flow path (flow path pattern) including the fuel cell U 316, it is also preferable that the exhaust gas (argon concentration-increased gas) emitted from the fuel gas chamber-side outlet of the fuel cell 316C and subjected to dehumidification by the dehumidification U 317b is returned to (just before) the buffer tank U 315a and processed again by the fuel cell U 316. This makes it possible to further reduce the hydrogen gas content in the exhaust gas and to increase the final recovery rate of argon gas.

Here, specifically, flow path switching valves may be provided just after the dehumidification U 317b and just before the buffer tank U 315a, and the exhaust gas may be returned to (just before) the buffer tank U 315a a predetermined number of times (within predetermined periods) by switching, as appropriate, these flow path switching valves and controlling, as appropriate, the gas transfer from the buffer tank U 315a. Naturally, the same processing as above may be also implemented on the exhaust gas from the fuel gas chamber-side outlet of the fuel cell U 116 (FIG. 1) or fuel cell U 216 (FIG. 6) to further reduce the hydrogen gas content in the exhaust gas.

Furthermore, where the targeted (or required) high argon concentration or high recovery rate can be achieved by returning the exhaust gas to the fuel cell U 316 as described above, it is possible to realize a flow path pattern <flow path 4> in which the filtering U 313 (and pressure control U 314a) in the above flow path 2 is omitted, and to generate high-purity argon gas (argon concentration-increased gas) using this <flow path 4>.

As described above in detail, according to the present disclosure, a mixed gas (kiln exhaust gas) containing a noble gas and an occlusion gas (occluded gas) emitted from a kiln can be regenerated into a reusable gas. Furthermore, a kiln system that reuses the regenerated gas can be provided.

In addition, the generated noble gas (argon) concentration-increased gas can be utilized in various fields other than kilns.

Furthermore, although limited to the case of embodiments that use a fuel cell, the demand for fuel cells, as well as, for example, neodymium (Nd—Fe—B) magnets manufactured using kilns, is expected to further increase as the social demand for reducing carbon dioxide emissions increases. In other words, fuel cells, and rare earth magnets manufactured using kilns, are a good match for and suited to the coming carbon-neutral society. Furthermore, for this reason, the embodiments of the present disclosure invention in which a fuel cell is used to process the kiln exhaust gas are well suited to the above-mentioned social demands, which will only increase in the future.

The foregoing embodiments are by way of examples of the present disclosure only and are not intended to limit thereto, thus many widely different alternations and modifications of the present disclosure may be constructed. Accordingly, the present disclosure is to be limited only as defined by the following claims and equivalents thereto.

### REFERENCE SIGNS LIST

1 kiln exhaust gas regeneration apparatus (kiln exhaust gas regeneration system) ; 111, 211, 311 catalytic poison removal unit (U) ; 112a, 312a blower U; 112aa, 215aa, 312aa, 315aa blower; 112ab, 215ab, 312ab, 315ab, 315ac buffer tank; 112b, 312b gas compression U; 112c, 312c tank U; 113, 118, 213, 313, 318 filtering U; 113F, 113F1, 113F2, 113F3, 113F4, 118F, 213F, 313F, 318F gas filter; 114a, 214a, 314a pressure control U; 114b, 214b, 314b buffer tank U; 114c, 214c, 314c Ar compression U; 115a, 215a, 315a buffer tank U; 115b, 215b, 315b gas compression U; 115c, 215c, 315c tank U; 115d, 215d, 315d gas compression U; 116, 216, 316 fuel cell U; 116C, 216C, 316C fuel cell; 117a, 217a, 317a pressure control U; 117b, 217b, 317b dehumidification U; 117c, 217c, 317c pressure control U; 119a, 319a pressure control U; 119b, 319b buffer tank U; 119c, 319c Ar compression U; 121, 221, 321 tank U; 122, 222, 322 delivery control U; 13, 23, 33 overall control U; 91 kiln; 92 fine powder trap U; and 93 alloy powder recovery container.

1.-15. (canceled)

16. A kiln exhaust gas regeneration apparatus comprising a noble gas extraction mechanism configured to:
receive a mixed gas emitted from a kiln, the mixed gas including a noble gas and an occlusion gas, and the kiln being configured to cause a metal occluding the occlusion gas to be heated and cause the occlusion gas to be released from the metal in an atmosphere including the noble gas; and
convert the mixed gas into a gas having an increased noble gas concentration by using:
a filter having different degrees of permeability between the occlusion gas and the noble gas; and/or
a fuel cell configured to oxidize the occlusion gas.

17. The kiln exhaust gas regeneration apparatus of claim 16, further comprising:
a noble gas delivery mechanism configured to send the gas having an increased noble gas concentration to the kiln or a gas storage tank for the kiln in order for the gas having an increased noble gas concentration to be reused as the atmosphere.

18. The kiln exhaust gas regeneration apparatus of claim 16, wherein the noble gas extraction mechanism is configured to:
convert the mixed gas into the gas having an increased noble gas concentration by using the filter and the fuel cell provided in downstream of an outlet of filtered gas in the filter.

19. The kiln exhaust gas regeneration apparatus of claim 18, wherein the noble gas extraction mechanism is configured to:
use a gas compressor to cause the mixed gas to act on the filter at a high pressure exceeding atmospheric pressure; and
introduce a gas taken out from the outlet of filtered gas in the filter into a fuel gas chamber of the fuel cell at a high pressure exceeding atmospheric pressure to oxidize the occlusion gas.

20. The kiln exhaust gas regeneration apparatus of claim 18, wherein the noble gas extraction mechanism is configured to:
further use another filter that is provided in downstream of a fuel gas chamber of the fuel cell and has different degrees of permeability between the occlusion gas and the noble gas to convert the mixed gas into the gas having an increased noble gas concentration.

21. The kiln exhaust gas regeneration apparatus of claim 16, wherein the noble gas extraction mechanism is configured to:
use the fuel cell and the filter provided in downstream of a fuel gas chamber of the fuel cell to convert the mixed gas into the gas having an increased noble gas concentration.

22. The kiln exhaust gas regeneration apparatus of claim 21, wherein the noble gas extraction mechanism is configured to:
use a gas compressor to introduce the mixed gas into the fuel gas chamber of the fuel cell at a high pressure exceeding atmospheric pressure to oxidize the occlusion gas; and
cause a gas taken out from the fuel gas chamber of the fuel cell to act on the filter at a high pressure exceeding atmospheric pressure.

23. The kiln exhaust gas regeneration apparatus of claim 16, wherein the noble gas extraction mechanism comprises the filter, and is configured to:
cause the mixed gas to act on the filter at a gas flow rate of a value set to reduce a residual occlusion gas concentration or a gas flow rate within a gas flow rate value range set to reduce the residual occlusion gas concentration; and
take out the gas having an increased noble gas concentration from the filter.

24. The kiln exhaust gas regeneration apparatus of claim 16, wherein the noble gas extraction mechanism comprises the filter, and is configured to:
cause the mixed gas to act on the filter at a gas pressure of a value set to increase a recovery rate of the noble gas, or at a gas pressure within a gas pressure value range set to increase the recovery rate of the noble gas;,-and
take out the gas having an increased noble gas concentration from the filter.

25. The kiln exhaust gas regeneration apparatus of claim 16, wherein the noble gas extraction mechanism comprises the filter, and is configured to:
cause the mixed gas to act on the filter at a gas pressure and/or a gas flow rate, as a filtering condition for the filter, determined according to the concentration of the noble gas or the occlusion gas in the received mixed gas; and
take out the gas having an increased noble gas concentration from the filter.

26. The kiln exhaust gas regeneration apparatus of claim 16, further comprising:
a controller configured to determine which one or both of the filter and the fuel cell to use, based on a concentration of the noble gas or the occlusion gas in the received mixed gas, based on a preset time schedule, or based on an external instruction,
wherein the noble gas extraction mechanism comprises the filter and the fuel cell, and is configured to:
convert the mixed gas into the gas having an increased noble gas concentration by using the determined filter and/or fuel cell.

27. The kiln exhaust gas regeneration apparatus of claim 26, wherein the controller is configured to:
select a flow path pattern to be used from a flow path pattern set including a flow path pattern connecting the filter and the fuel cell located in downstream thereof, a flow path pattern connecting the fuel cell and the filter located in downstream thereof, and a flow path pattern including the filter but not including the fuel cell, based on the concentration of the noble gas or the occlusion gas in the received mixed gas, based on a preset time schedule, or based on an external instruction, and
wherein the noble gas extraction mechanism comprises the filter, the fuel cell, and flow path switching valves configured to embody each flow path pattern included in the flow path pattern set, and is configured to:
embody the selected flow path pattern; and
convert the mixed gas into the gas having an increased noble gas concentration.

28. The kiln exhaust gas regeneration apparatus of claim 27, wherein the controller is configured to:
first select the flow path pattern connecting the fuel cell and the filter located in downstream thereof; and
then select the flow path pattern connecting the filter and the fuel cell located in downstream thereof.

29. A kiln exhaust gas regeneration system comprising a noble gas extraction mechanism configured to:
receive a mixed gas emitted from a kiln, the mixed gas including a noble gas and an occlusion gas, and the kiln being configured to cause a metal occluding the occlusion gas to be heated and cause the occlusion gas to be released from the metal in an atmosphere including the noble gas; and
convert the mixed gas into a gas having an increased noble gas concentration by using:
a filter having different degrees of permeability between the occlusion gas and the noble gas; and/or
a fuel cell configured to oxidize the occlusion gas.

30. A kiln system comprising:
a kiln configured to: cause a metal occluding an occlusion gas to be heated; and cause the occlusion gas to be released from the metal in an atmosphere including a noble gas;
a noble gas extraction mechanism configured to:
receive a mixed gas emitted from the kiln and including the noble gas and the occlusion gas; and convert the mixed gas into a gas having an increased noble gas concentration by using a filter having different degrees of permeability between the occlusion gas and the noble gas, and/or a fuel cell configured to oxidize the occlusion gas; and
a noble gas delivery mechanism configured to send the gas having an increased noble gas concentration to the kiln or a gas storage tank for the kiln in order for the gas having an increased noble gas concentration to be reused as the atmosphere.
